(19) United States
(12) Patent Application Publication
(10) Pub. No.: US 2002/0134407 A1
(43) Pub. Date: Sep. 26, 2002

(54) Magnetic head cleaning tape and cleaning method for magnetic heads

(75) Inventor: Haruo Urai, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/098,487

(22) Filed: Mar. 18, 2002

(30) Foreign Application Priority Data
Mar. 22, 2001 (JP) 82601-2001

(51) Int. Cl. B08B 7/00

(52) U.S. Cl. 134/6; 15/210.1; 15/DIG. 12

(57) ABSTRACT

In order to keep satisfactory the state of contact between a magnetic tape and a magnetic head, dust having accumulated between bumps of a magnetic head having a plurality of bumps is to be removed.

This is a magnetic head cleaning tape for cleaning a magnetic head where a groove is present in the vicinity of the plane of contact between the magnetic head and the magnetic tape, and is provided with flexible raised fibers as long as or longer than the depth of the groove and tape base, the flexible raised fibers being disposed on the surface of the tape base. A flexible raised fiber section which is an area on the tape base having the flexible raised fibers is formed all over in the widthwise direction of the tape and continuously in the direction of the tape length. It may as well be periodically formed in the direction of the tape length. Dust is removed by shifting the magnetic head over the raised fiber section in a direction normal to the running direction of the tape.

### BACKGROUND OF THE INVENTION

1. Field of the Invention

The present invention relates to a cleaning tape for use in the cleaning of magnetic heads of magnetic tape apparatuses and a cleaning method therefor, and more particularly to the structure of a cleaning tape for use in the cleaning of magnetic heads of magnetic tape apparatus having a linear format and a cleaning method therefor.

2. Description of the Related Art

Dust coming off magnetic coating, such as magnetic powder, dust or the like may stick to magnetic heads of magnetic tape apparatuses, and the sticking of such foreign matter to magnetic heads deteriorates the writing/reading efficiency of the magnetic heads, inviting more frequent occurrence of read errors or other faults.

In view of this problem, various techniques for cleaning magnetic heads have been proposed already. For instance, the Examined Japanese Patent Application No. 08-001695 discloses as an abrasive cleaning tape a cleaning tape coated with abrasive particles. This kind of cleaning tape is usually used for the cleaning of helical scanning type magnetic heads of magnetic tape apparatuses. However, such an abrasive head cleaning tape is unsuitable for the cleaning of heads sensitive to their gap depth, such as magneto resistance type read heads (MR heads), because if the gap becomes shallower as an MR head is polished, its characteristics may be varied to make itself more susceptible to read errors.

The Examined Japanese Utility Model Application No. 07-034487 discloses a case in which minute protrusions are formed on the surface of a cleaning tape. Dust scraped off the head surface is deposited between the minute protrusions to enhance the dust removing effect, but this again involves the problem that it cannot be expected to clean a magnetic head whose surface is more uneven than the height of the minute projections.

The Unexamined Japanese Utility Model Application No. 06-26023 discloses an example of cleaning tape prepared by weaving fibers. This tape is non-abrasive and accordingly used for the cleaning of heads sensitive to their gap depth, such as MR heads. However, the cleaning effect of the uneven surface of the fabric works only where the tape and the head comes into contact, and concave parts of a head having a highly rugged surface do not contact with the tape, posing the problem that those parts cannot be cleaned.

The Unexamined Japanese Patent Application No. 10-21516 discloses a method by which, in view of the problem that a magnetic head wider or about as wide as a cleaning tape cannot be cleaned as effectively by the edges of the tape on account of the unevenness of tape stress reduces the cleaning effect there, the head is shifted in the widthwise direction of the tape so that the head be cleaned in the middle part of the tape and thereby cleared of dust all over its surface. According to the disclosure, earlier disclosed tapes, whether abrasive or made of cloth, can be used for head cleaning by this method. However, even this method cannot bring the concave parts of a head having a highly rugged surface into contact with the tape, and the problem that those parts remain uncleaned cannot be solved.

A first problem to be solved by the present invention is that a magnetic head having a plurality of bumps is subject to the accumulation of dust between the bumps, and the dust having accumulated there cannot be removed with any conventional head cleaning tape.

The reason for this problem will be explained below with reference to drawings.

There are two types of magnetic tape apparatus including a helical scanning type in which the magnetic head writes information while rotating at high speed and a linear format type in which the head remains still and a magnetic tape runs at high speed and writes information. The latter, a linear format type magnetic tape apparatus, needs a read while write (RWW) function to meet a high reliability requirement in data writing by reading the data being written on a magnetic tape immediately after they are written and checking whether or not the data have been accurately written. Therefore, it requires two different head including a write head and a read head. These write head and read head are arranged with a prescribed spacing between them so that the writing magnetic field at the time of writing may not become sneak path noise to the read head. The spacing is usually 0.5 to a few mm.

By arranging the write head and the read head on a single seamless cylindrical curved surface (single bump) consecutively, the area of contact between the tape and the curved surface is increased to enable, when the tape is sliding at high speed, a large quantity of air film to be dragged in over the head surface, resulting in a deteriorated state of contact between the heads and the tape, a consequent deterioration of read and write characteristics and greater susceptibility to a drop in reliability. To obviate this disadvantage, usually a groove 30 is provided between a write head bump 10 and a read head bump 20 as shown in FIG. 1A, and the occurrence of unnecessary air film is thereby restrained. This head structure in which each head has two convex parts to come into contact with the tape is known as a double bump structure. A magnetic head of a double bump structure can keep the state of contact between the magnetic tape 4 with the write head 10 and the read head 20 satisfactory as shown in FIG. 1B even when the tape is sliding at high speed.

When a magnetic tape is run for a long time, exfoliation from the magnetic tape and dust dragged in from outside accumulates as dust matter 5 in grooves 30, 31 and 32 formed beside bumps 10 and 20 as shown in FIG. 2A. Running of the tape in such a state causes dust matter to be dragged in and to adhere to the running tape, and thereby expands the gap between the heads and the magnetic tape to invite writing and/or reading errors. To prevent it, usually a head cleaning tape 6 is run to remove the dust matter 5 having stuck to the head surface as shown in FIG. 2B. In this process, the dust matter 5 in the groove 32 beside head bump 20 on the outlet side of the cleaning tape 6 is blown out by an air flow arising from the running of the cleaning tape, and disappears. When the running direction of the cleaning tape is reversed, dust matter in the groove 31 beside the bump on the other side comes off as shown in FIG. 2C.

However, the dust matter 5 in the groove 30 between the head bumps, as it is walled in by the bumps 10 and 20 on two side, is not swept away by the running of the cleaning tape in either direction, and stays there for a long time as shown in FIG. 2C. As a consequence, dust matter in the groove 30 between the bumps is sometimes dragged onto the head surface along with the normal running of the magnetic tape, and gives rise to a write or read error. Thus, there has been no cleaning tape capable of effectively removing such dust matter between the bumps of head having a plurality of bumps.

A second problem is that any other means of removing dust matter in the groove between head bumps than a head cleaning tape is practically inefficient for use in tape drives.

Dust matter in the groove between head bumps may be wiped off with a swab or the like, but usually magnetic heads are within a magnetic tape apparatus beyond the easy reach of a swab or the like. Moreover, when dust is wiped off with a swab or the like, dust matter in corners formed by the bottom and side walls of the groove cannot be completely removed because the tip of such a tool has a finite radius of curvature.

### SUMMARY OF THE INVENTION

An object of the present invention is to provide a magnetic head cleaning tape capable of efficiently removing dust matter in a groove between head bumps, which cannot be removed with any conventional head cleaning tape.

Thus a first object of the invention is to enhance reliability by providing a novel magnetic head cleaning tape, efficiently removing dust matter in a groove between head bumps therewith and preventing write/read errors from occurring in a magnetic tape apparatus using the magnetic heads.

Dust matter in a groove between the bumps of a magnetic head in a deep position in a magnetic tape apparatus can be effectively removed by wiping off with a swab or the like, but this method requires exposure of the magnetic head by disassembling the magnetic tape apparatus or otherwise, whose execution would require specialized skills. A second object of the invention is to improve the maintenance ease of magnetic tape apparatuses by the use of a magnetic head cleaning tape according to the invention, which would enable even an unskilled person to easily remove dust matter in the groove between head bumps.

A magnetic head cleaning tape according to the invention is a magnetic head cleaning tape for cleaning a magnetic head having a groove in the vicinity of the face of the magnetic head coming into contact with a magnetic tape, the cleaning tape comprising:

flexible raised fibers longer than the depth of the groove and a tape base, wherein the flexible raised fibers are provided on the surface of the tape base.

In a magnetic head cleaning tape according to the invention,

the flexible raised fiber section, which is an area of the tape base on which the flexible raised fibers are provided, is formed all over in the widthwise direction of the tape and continuously in the direction of the tape length.

In a magnetic head cleaning tape according to the invention,

the flexible raised fiber section, which is an area of the tape base on which the flexible raised fibers are provided, is periodically provided in the direction of the tape length and all over in the widthwise direction of the tape in the area where the flexible raised fiber section is formed.

In a magnetic head cleaning tape according to the invention,

relationships of La>Lh, Lb>>Lh and m·L=2·n·Lh may hold, where La is the length of the flexible raised fiber section in the running direction of the tape; Lb, the distance to the adjoining flexible raised fiber section; L=La+Lb, the period of the flexible raised fiber section; Lh, the length of each magnetic head in the direction of the tape length; and m and n, mutually prime integers.

In another magnetic head cleaning tape according to the invention,

relationships of La>Lh and Lb>Lh may hold, where La is the length of the flexible raised fiber section in the running direction of the tape; Lb, the distance from an end of the flexible raised fiber section to the adjoining flexible raised fiber section; L (=La+Lb), the period of the flexible raised fiber section; and Lh, the length of each magnetic head in the direction of the tape length; and

in the vicinity of one end of each flexible raised fiber section is provided at a first distance a magnetic pattern all over the section in the widthwise direction of the tape.

In another magnetic head cleaning tape according to the invention,

arrays of two different magnetic patterns are on two sides of the flexible raised fiber section, a first magnetic pattern is provided away from the flexible raised fiber section by the first distance, and the array of a second magnetic pattern differing in pattern information is provided on the reverse side to the first pattern array away from the flexible raised fiber section by a second distance.

In a magnetic head cleaning tape according to the invention,

the flexible raised fiber sections, which are areas having the flexible raised fibers on the tape base, may be provided at both ends in the widthwise direction of the tape, and continuously formed in the direction of the tape length.

In a magnetic head cleaning tape according to the invention,

the material of the tape base is polyester fibers, and that of the flexible raised fibers is also polyester fibers.

In a magnetic head cleaning tape according to the invention, the magnetic pattern arrays may be formed of a magnetic material stuck onto the tape base.

In a magnetic head cleaning tape according to the invention,

the magnetic pattern arrays may be formed by weaving fibers containing a magnetic material into the material itself of the magnetic tape.

Another aspect of the present invention provides for a method for a magnetic tape apparatus to clean the magnetic head, the magnetic tape apparatus having a means for running the cleaning tape and a means for shifting the position of the magnetic head in the widthwise direction of the tape, the cleaning tape having over its tape base a flexible raised fiber section in which flexible raised fibers are formed to be oriented in the depthwise direction of a groove in the magnetic head having that groove in the widthwise direction of the tape, and further formed all over in the widthwise direction of the tape and continuously in the direction of the tape length, whereby:

the cleaning tape is run over a predetermined distance;

the magnetic head is shifted toward one end of the cleaning tape in its widthwise direction;

the cleaning tape is run in that state over a prescribed distance and stopped it;

the magnetic head is shifted toward the other end of the cleaning tape;

the cleaning tape is run and stopped it again; and

the magnetic head is shifted to its original position, i.e. the central section of the cleaning tape in its widthwise direction.

Still another aspect of the invention provides for a method for a magnetic tape apparatus to clean the magnetic head, the magnetic tape apparatus having a means for running the cleaning tape and a means for shifting the position of the magnetic head in the widthwise direction of the tape, the cleaning tape having over its tape base a flexible raised fiber section, which is an area on the tape base and in which flexible raised fibers are formed to be oriented in the depthwise direction of a groove in the magnetic head having that groove in the widthwise direction of the tape, the flexible raised fiber section being provided periodically in the lengthwise direction of the tape and over the full width of the tape in the area where the flexible raised fiber section is formed, and relationships of La>Lh and Lb>>Lh, m·L=2·n·L hold for the cleaning tape, where La is the length of the flexible raised fiber section in the running direction of the tape; Lb, the distance to the adjoining flexible raised fiber section; L=La+Lb, the period of the flexible raised fiber section; Lh, the length of each magnetic head in the direction of the tape length; and m and n, mutually prime integers;

the cleaning tape is run over a predetermined distance;

the magnetic head is shifted toward one end of the cleaning tape in its widthwise direction;

the cleaning tape is run in that state as far as Lh and stopped it;

the magnetic head is shifted toward the other end of the cleaning tape and returned to its original position;

the cleaning tape is run as far as Lh and stopped again;

the magnetic head is shifted farther toward the other end of the cleaning tape;

the cleaning tape is run as far as Lh and stopped again;

the magnetic head is shifted to its original position, i.e. the central section of the cleaning tape in its widthwise direction, and the foregoing steps are repeated n times.

Yet another aspect of the invention provides for a method for a magnetic tape apparatus to clean the magnetic head, the magnetic tape apparatus having a means for running the magnetic head cleaning tape and a means for shifting the position of the magnetic head in the widthwise direction of the tape, wherein relationships of La>Lh and Lb>Lh hold, where La is the length of the flexible raised fiber section in the running direction of the tape; Lb, the distance from an end of the flexible raised fiber section to the adjoining flexible raised fiber section; L (=La+Lb), the period of the flexible raised fiber section; and Lh, the length of the magnetic head in the direction of the tape length; and in the vicinity of at least one end of each flexible raised fiber section is provided at a first distance a magnetic pattern all over the section in the widthwise direction of the tape;

the magnetic head output is monitored while running the cleaning tape;

after detecting the magnetic head output, the tape is further run by sh1 and stopped;

the magnetic head is shifted toward one end of the tape in its widthwise direction;

the cleaning tape is run in that state as far as La; and

the magnetic head is shifted toward the other end of the tape in its widthwise direction and returned to its original position.

Another magnetic head cleaning method according to the invention further includes steps of:

monitoring the magnetic head output while running the cleaning tape;

after detecting the magnetic head output, further running the tape by sh1 and stopping it;

shifting the magnetic head toward the other end of the tape in its widthwise direction;

the cleaning tape is run in that state as far as La; and

the magnetic head is shifted toward that one end of the tape in its widthwise direction and returned to its original position.

Another aspect the invention provides for a method for a magnetic tape apparatus to clean its magnetic head, the magnetic tape apparatus having a means for running a cleaning tape and a means for shifting the position of the magnetic head in the widthwise direction of the tape, wherein relationships of La>Lh and Lb>Lh hold, where La is the length of a flexible raised fiber section in the running direction of the tape; Lb, the distance from an end of the flexible raised fiber section to the adjoining flexible raised fiber section; L (=La+Lb), the period of the flexible raised fiber section; and Lh, the length of the magnetic head in the direction of the tape length; and in the vicinity of one end of each flexible raised fiber section is provided at a first distance a first magnetic pattern all over the section in the widthwise direction of the tape, and a second magnetic pattern differing in pattern information is provided on the reverse side to the first pattern array away from the flexible raised fiber section by a second distance;

in a first running direction from the first magnetic pattern to the flexible raised fiber section in the vicinity:

the magnetic head output is monitored while running the cleaning tape;

after detecting the first magnetic pattern, the tape is further run by sh1 and stopped;

the magnetic head is shifted in a first direction in the widthwise direction of the tape;

the cleaning tape is run in that state as far as La; and

the magnetic head is shifted in a second direction reverse to the first direction in the widthwise direction of the tape; and

in a second running direction from the second magnetic pattern to the flexible raised fiber section in the vicinity:

the magnetic head output is monitored while running the cleaning tape; after detecting the second magnetic pattern, the tape is further run by sh2 and stopped;

the magnetic head is shifted in the first direction in the widthwise direction of the tape;

the cleaning tape is run in that state as far as La; and

the magnetic head is shifted in the first direction reverse to the second direction in the widthwise direction of the tape.

(Operations)

As shown in FIG. 3A, flexible raised fibers 61 are provided on a magnetic head cleaning tape 6 according to the present invention. These flexible raised fibers are substantially upright from the tape surface when subjected to no pressure from above. If a tape having an uprightly raised fiber section is simply wound around a hub, the effective thickness of the wound tape will increase, resulting in a shorter length of the tape that can be wound in a given diameter, and this is impractical. As the magnetic head cleaning tape 6 according to the invention has a flexible raised fiber section, when the tape is wound round a hub 65, the tension of the tape subjects the tape to pressure from the hub 65 side, and the raised fiber section is dragged in with the fibers inclined as illustrated in FIG. 3B. As a result, the length of the tape that can be wound in a given tape winding diameter is increased, which serves to extend the useful life of this magnetic head cleaning tape.

As shown in FIG. 3C, after running the magnetic head cleaning tape 6 in the direction of arrow 6a while keeping it in contact with a magnetic head 1, the run is stopped. Usually the tape is pressed against the magnetic head by its own tension. This pressure causes raised fibers 61a in contact with the bumps 10 and 20 of the head are inclined in a direction reverse to the running direction of the tape and pressed against the bump 10 or 20. However, the raised fibers 61a of the tape in the groove 30 between the head bumps rise as the pressure working on the tape is eliminated. By presetting the height 62 of these raised fibers substantially equal to or somewhat greater than the depth 12 of the groove of the magnetic head bumps, the tips of the raised fibers are caused to come into contact with the bottom face of the groove 30 between the bumps.

As illustrated in FIG. 4, if the dust matter 5 is in the groove 30 between the magnetic head bumps, when this magnetic head is positioned facing the raised fiber section of the cleaning tape, the tips of the raised fibers 61a will come into contact with the bottom face of the groove between the bumps, and the tips of the raised fibers 61a will also come into contact with the dust matter 5 stuck to the bottom face. In this state where the tips of the raised fibers 61a can come into contact with the dust matter 5, then the magnetic head is shifted in a vertical direction (the widthwise direction of the tape) to the running direction 6a of the tape as indicated by arrow la. This shift causes the tips of the raised fibers 61a to shift the dust matter 5 in parallel to the groove between the magnetic head bumps, and in that process scrape the dust matter 5 off the bottom face of the groove, thereby clearing the groove between the bumps of the dust matter 5.

### BRIEF DESCRIPTION OF THE DRAWINGS

The novel features believed to be characteristic of the invention are set forth in the appended claims. The invention itself, however, as well as other features and advantages thereof, will be best understood from the detailed description which follows, when read in conjunction with the accompanying drawings, wherein:

FIG. 1A shows a perspective view of a magnetic head, and FIG. 1B a perspective view of the positional relationship between the magnetic head and a magnetic tape;

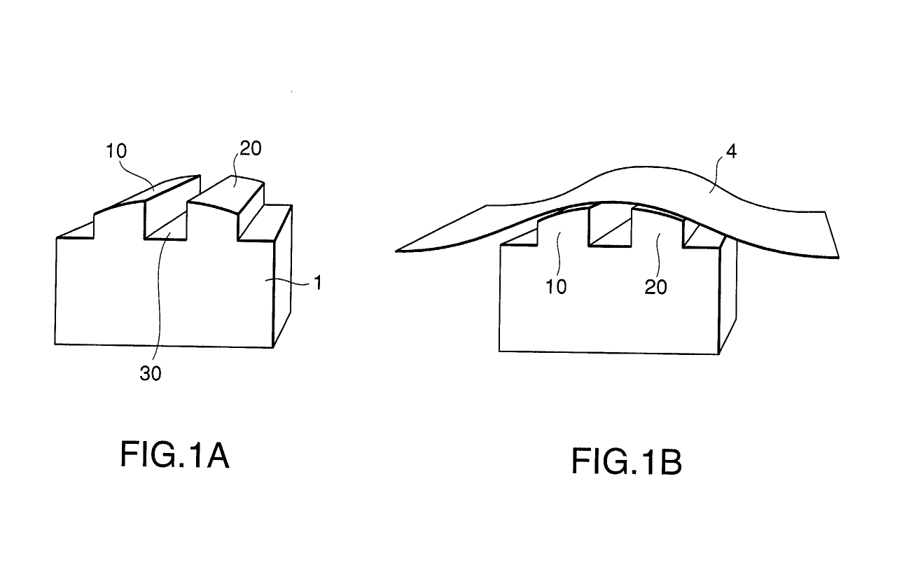

FIGS. 2A, 2B and 2C show sectional views of the positional relationship between a magnetic head and a magnetic tape of a cleaning tape according to the prior art;

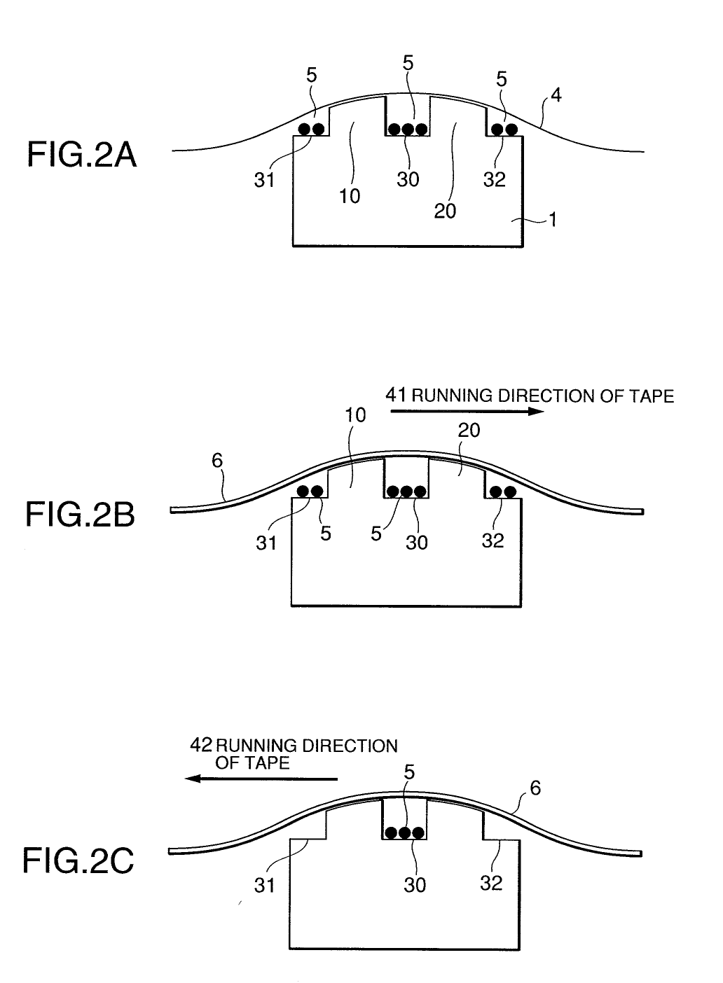

FIGS. 3 illustrate a magnetic head cleaning tape, which is a first preferred embodiment of the invention, FIG. 3A showing a schematic view, FIG. 3B, a state in which the tape is partly wound, and FIG. 3C, a sectional view of the relationship between the cleaning tape and the magnetic head;

FIG. 4 illustrates the operation of the invention;

FIG. 5 illustrate the operation of the invention, the cleaning tape being placed underneath the magnetic head in FIG. 5A, the tape being beside the head in FIG. 5B, and the tape being placed over the head in FIG. 5C;

FIG. 6A illustrates the structure of a second of the invention, and FIG. 6B shows a sectional view thereof;

FIG. 7 is a flow chart of the operation of the second embodiment of the invention;

FIG. 8A illustrates the structure of a third preferred embodiment of the invention, and FIG. 8B shows a sectional view thereof;

FIG. 9 is a flow chart of the operation of the third embodiment of the invention; and

FIG. 10A illustrates the structure of a fourth preferred embodiment of the invention, and FIG. 10B, the relationship between the cleaning tape and the magnetic head.

### DESCRIPTION OF THE PREFERRED EMBODIMENTS

Next will be described in detail the first preferred embodiment of the present invention with reference to drawings.

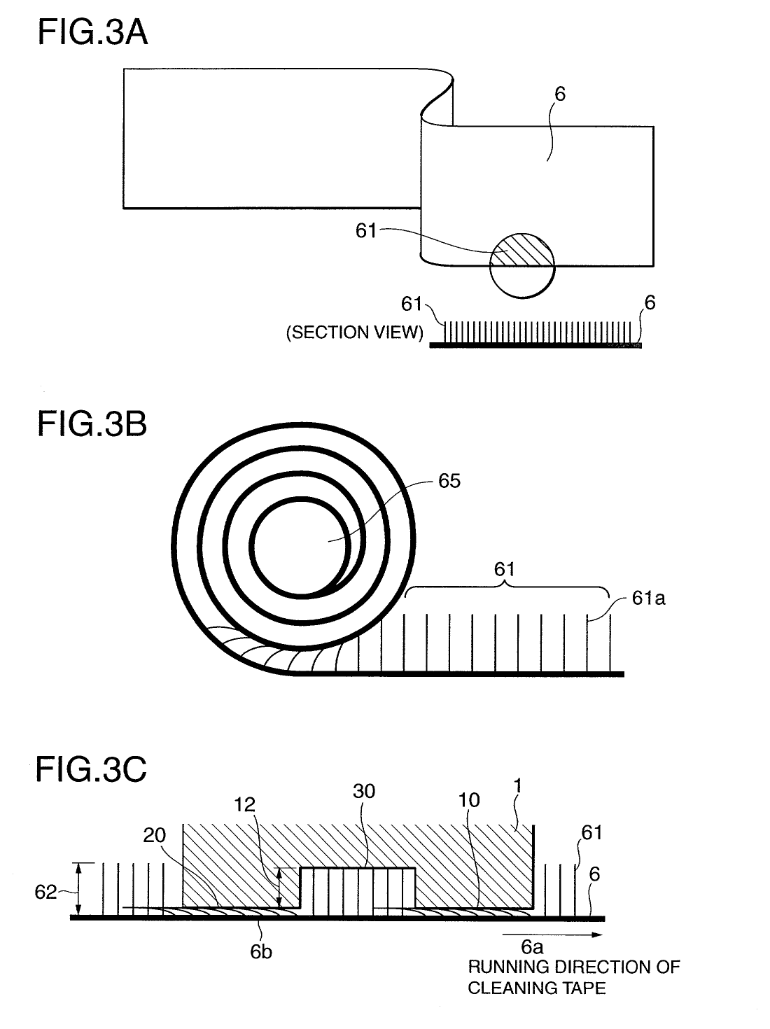

As shown FIG. 3A and FIG. 3C, a magnetic head cleaning tape 6, which is the first preferred embodiment of the invention, is provided with a tape base 6b and flexible raised fibers 61 provided all over the surface of the tape base 6b. These flexible raised fibers 61 are disposed to be substantially upright from the tape surface when subjected to no pressure from above. As illustrated in FIG. 3B, in a state in which the cleaning tape is wound around a hub 65, these raised fibers 61a are inclined in the circumferential direction as subjected to pressure between rounds of the tape to reduce the distance between the rounds, and the long tape is wound relative to the tape winding diameter. Regarding the tape materials, the tape base 6b is made of conventional woven fibers, and the raised fibers are polyester fibers. The raised fibers are disposed all over the surface of the tape base. The raised fibers can be planted on the base easily by a well-known pile weaving method.

The length of these the raised fibers 61a is set equal to or somewhat greater than the depth 12 of the groove 30 between the bumps of the magnetic head as shown in FIG. 3C. Therefore, this tips of the raised fibers can reach dust matter 5 stuck to the bottom face of the groove between the bumps.

A magnetic tape apparatus whose head is cleaned according to the invention has a tape running means for running the cleaning tape and a magnetic head shifting means for shifting the position of the magnetic head in the widthwise direction of the tape but the description of the tape running means and the magnetic head shifting means is dispensed with because they are covered by technology well known to persons skilled in the art. Whereas running a tape and shifting a magnetic head will be described with reference to each embodiment of the invention, they are supposed to be performed by the tape running means and the magnetic head shifting means, respectively.

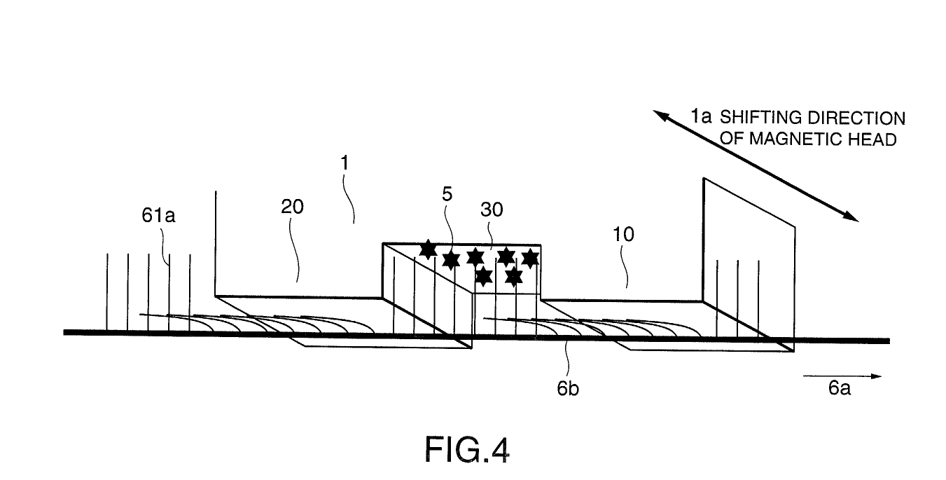

Next will be described the operation of the first embodiment of the invention, i.e. the operation to remove the dust matter 5 stuck in the groove 30 between the magnetic head bumps using this magnetic head cleaning tape with reference to FIGS. 3 and 4.

Thus, after running this cleaning tape over a predetermined distance and stopping the tape 6, the magnetic head 1 is shifted toward one end of the cleaning tape 6 in its widthwise direction until that one end of the tape 6 and one end of the magnetic head 1 meet each other. The tape 6 need not be shifted until that one end of the tape 6 and that one end of the magnetic head meet, and this is true of their respective other ends. After that, the cleaning tape 6 is let continue to run, and is brought to halt when an unused raised fiber section has reached the magnetic head 1.

Next, the magnetic head 1 is shifted toward the other end of the cleaning tape 6 in its widthwise direction until that other end of the tape 6 and the other end of the magnetic head 1 meet each other. Then, the cleaning tape 6 is run again and brought to halt when an unused raised fiber section has reached the magnetic head 1. After that, by shifting the magnetic head 1 back to its original position (substantially the central part in the widthwise direction of the cleaning tape), the dust matter 5 in the groove 30 between the bumps is removed.

Next to describe the operation with reference to drawings, if the dust matter 5 is in the groove 30 between the magnetic head bumps as shown in FIG. 4, when this magnetic head 1 is positioned over the raised fiber section 61 of the cleaning tape, the tips of the raised fibers 61a come into contact with the bottom face of the groove 30 between the bumps, and the tips of the raised fibers 61a also come into contact with the dust matter 5 stuck to the bottom face. In a state in which the tips of the raised fibers 61a thus can be in contact with the dust matter 5, the magnetic head 1 is shifted in a direction normal to the tape running direction 6a and toward one end of the tape in its widthwise direction as indicated by arrow la.

This shift causes the tips of the raised fibers 61a to move the dust matter 5 in a direction parallel to the groove 30 between the magnetic head bumps (the lengthwise direction of the groove, i.e. the widthwise direction of the tape), and in that process to scrape the dust matter 5 off the bottom face of the groove, thereby removing the dust matter 5 on the bottom face of the groove 30 between the bumps. Thus, the basic operation according to the invention includes having the tips of the raised fibers 61a scrape off the dust matter 5 on the bottom face of the groove 30 between the bumps in the direction of the groove between the bumps, which any conventional magnetic head cleaning tape cannot access.

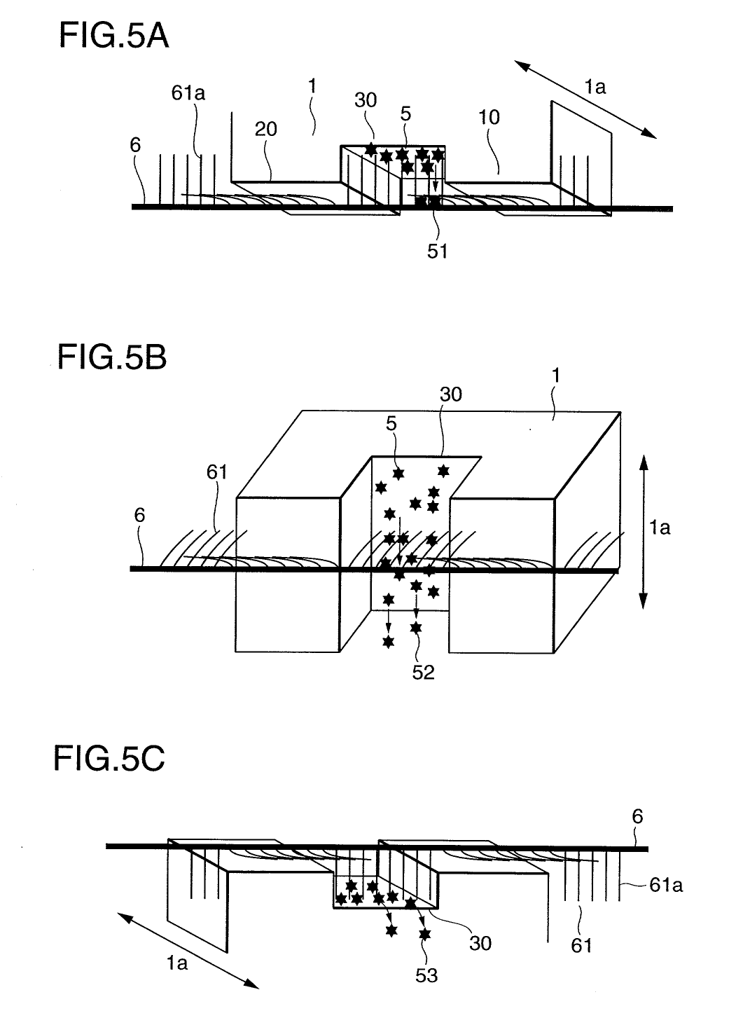

The dust matter 5 can be removed in a number of typical processes as shown in FIGS. 5. As illustrated in FIG. 5A, if the magnetic head 1 is positioned in a direction perpendicular to the magnetic head cleaning tape 6, scraped dust matter 51 will be taken into gaps among the raised fibers 61a of the cleaning tape. The dust matter 51 taken into the gaps to be removed is rolled around the take-up reel of the tape along with the running of the cleaning tape 6, and will never stick to the head surface again.

Next, as illustrated in FIG. 5B, if the lengthwise direction of the groove 30 between the bumps of the magnetic head 1 is formed in the perpendicular direction and the cleaning tape 6 is pressed against the magnetic head 1, when the head 1 comes into contact with the raised fiber section 61 and shifts in the perpendicular direction la, the scraped dust matter 52 will fall underneath the head 1. The dust matter 52 having fallen underneath the magnetic head 1 will never stick to the head surface again.

Or, as shown in FIG. 5C, if the open side of the groove 30 between the bumps is upward in the perpendicular direction and the cleaning tape 6 is over the magnetic head 1, when the magnetic head 1 meets the raised fiber section 61 and the head 1 shifts in the widthwise direction of the tape , dust matter scraped off by the tips of the raised fiber section is swept out of the groove 30 between the magnetic head bumps as indicated by reference numeral 53. The swept dust matter 53 will never stick to the magnetic head 1 again.

The first embodiment of the invention provides the benefit of being able to remove dust matter having accumulated is in the groove between the magnetic head bumps, which cannot be fully removed by any conventional cleaning tape. Moreover, when this cleaning tape is to be wound around a reel, the wound tape having flexible raised fibers can be thinner than that having inflexible rigid raised fibers, which means the benefit of allowing the same reel to accommodate a longer cleaning tape.

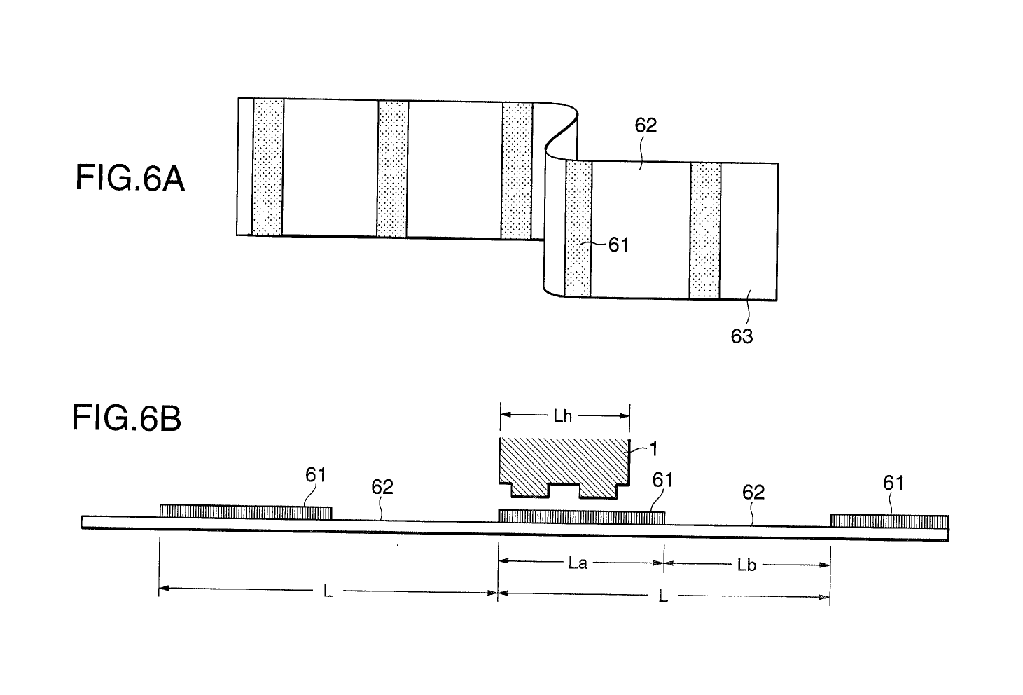

The configuration of the second preferred embodiment of the present invention is illustrated in FIG. 6. In this embodiment, as shown in FIG. 6A, the flexible raised fiber section 61, wherever it exists on the magnetic head cleaning tape 6, is provided over the whole width in the widthwise direction. However, in the direction of the tape length, it is provided only periodically, resulting in a characteristic that the raised fiber section 61 is present somewhere and absent elsewhere.

The periodicity configuration of that cleaning tape 63 in its cross section in the thickness direction is shown in FIG. 6B. The period L in which the flexible raised fiber section is composed is L=La+Lb, where La is the length of the flexible raised fiber section 61 of the cleaning tape 63 in the running direction of the tape, and Lb, the distance to the adjoining flexible raised fiber section. On the other hand, it is configured in advance that that relationships of La>Lh and Lb>>La hold, where Lh is the length of the magnetic head 1 in the running direction of the tape. There further holds a relationship of m·L=2·n·Lh, where m and n are mutually prime integers.

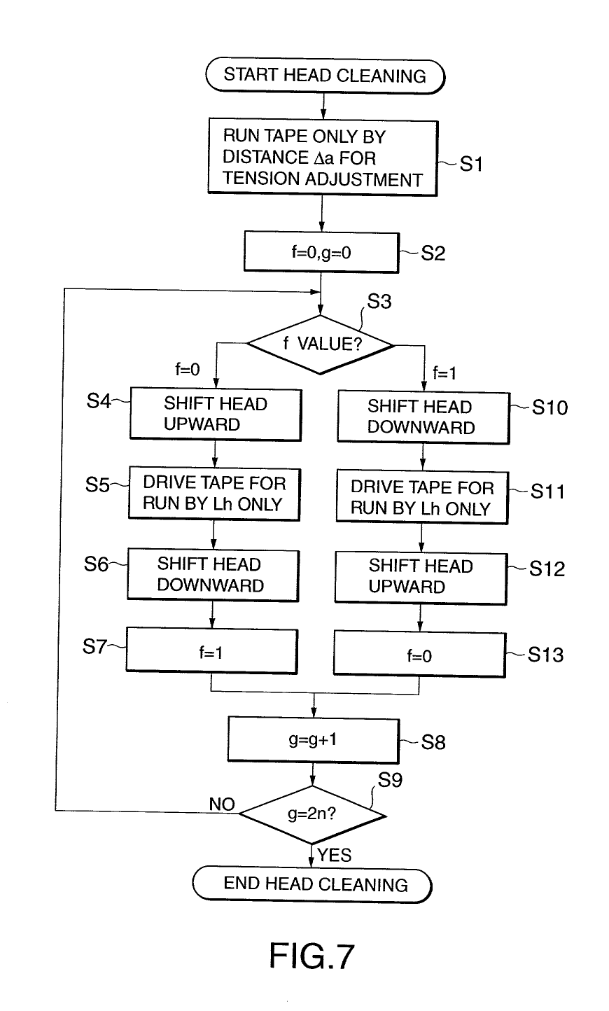

The operation of magnetic head cleaning that is used will be explained with reference to FIGS. 6 and FIG. 7. Thus, in a state in which this cleaning tape is kept in contact with the magnetic head 1, after the tape is run over a predetermined distance Δa to adjust its tension (Step 1, Step being hereinafter abbreviated to S) and stopped, flags are set to be f =0 and g=0 (S2).

To check f here (S3), f=0 and therefore the magnetic head 1 is shifted in a first direction normal to the running direction of the tape (the widthwise direction of the tape, e. upward in FIG. 6A) until one end of the tape 63 and one end of the magnetic head 1 the length (S4). The tape 63 need not be shifted until that one end of the tape 63 and that one end of the magnetic head 1 meet, and this is true of their respective other ends.

At this point of time, dust matter 5 in the groove between the bumps is scraped of with the tips of the raised fibers 61a. With the head position kept as it is, the tape 63 is run as far as the length Lh of the magnetic head 1 (S5) and after it is stopped, the head 1 is shifted in a second direction (e.g. downward in FIG. 6A) reverse to the first direction to be returned to its original position (S6) . Here the flags are set to be f=1 (S7), and the value of g is increased by 1 (S8). Then, the head 1 is shifted in the second direction to a position where the other end of the tape 6 and the other end of the magnetic head 1 meet each other (S10) and, after the tape is run as far as the head length Lh and stopped (S11), the head 1 is shifted in the first direction to be returned to its original position (S12).

Here the flags are set to be f=1 (S13), and the value of g is increased by 1 (S8).

As this sequence is repeated n times, while the head passes the flexible raised fiber section exactly m times because of the relationship of m·L=2·n·Lh, dust matter 5 on the bottom face of the groove 30 between the magnetic head bumps is removed by the flexible raised fiber section 61 with neither excess nor shortage. Furthermore, in the meantime the bump surface of the magnetic head passes a section where there are no flexible raised fibers 61, i.e. a flat section 62 (whose length is Lb) m times. The magnetic head cleaning effect according to the prior art can be achieved by composing this part of a conventional fabric or abrasive tape.

The second preferred embodiment of the invention provides an effect to clean the bump surface of the head in addition to the benefit of the first embodiment and, moreover, an additional remarkable effect of permitting the removal of dust matter in the groove between bumps, which was impossible by the prior art.

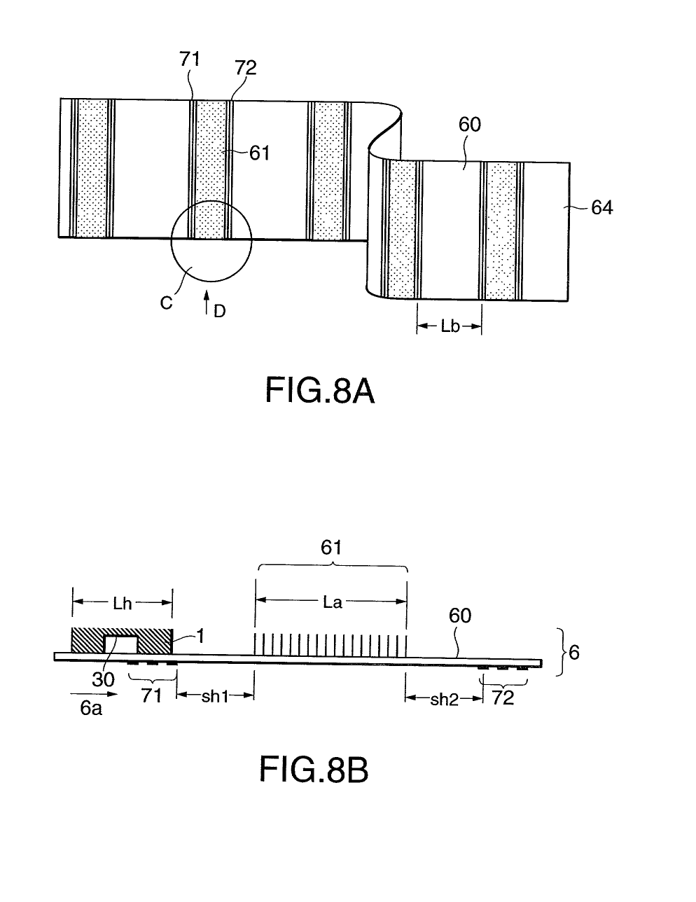

The third preferred embodiment of the present invention will now be described with reference to FIGS. 8. In a magnetic head cleaning tape 64 in this embodiment, as shown in FIGS. 8A and 8B, the flexible raised fiber section 61, of which the width is equal to that of the tape and the length is La, is periodically provided over a cleaning tape base 60. Further, in the vicinity of and sh1 away from that flexible raised fiber section 61 is provided a first magnetic pattern 71. In the vicinity of the section 61 in the other direction and sh2 away from the same, a second magnetic pattern 72 may be provided at the same time.

Magnetic patterns such as those denoted by reference numerals 71 and 72 can be fabricated by either weaving fibers infiltrated with a magnetic material or painting or vapor-depositing a magnetic material on the tape base and magnetically recording a specific magnetic pattern on that magnetic material. This flexible raised fiber section 61 is periodically arranged at a spacing Lb. Thus with the lengths of sh1, sh2 and the magnetic pattern being ignored as they are sufficiently less than La and Lb, the arrangement period L of the flexible raised fiber section is equal to La=Lb. Further, this magnetic head cleaning tape 64 is configured to have relationships of La>Lh and Lb>Lh, where Lh is the length of the magnetic head in the running direction of the tape.

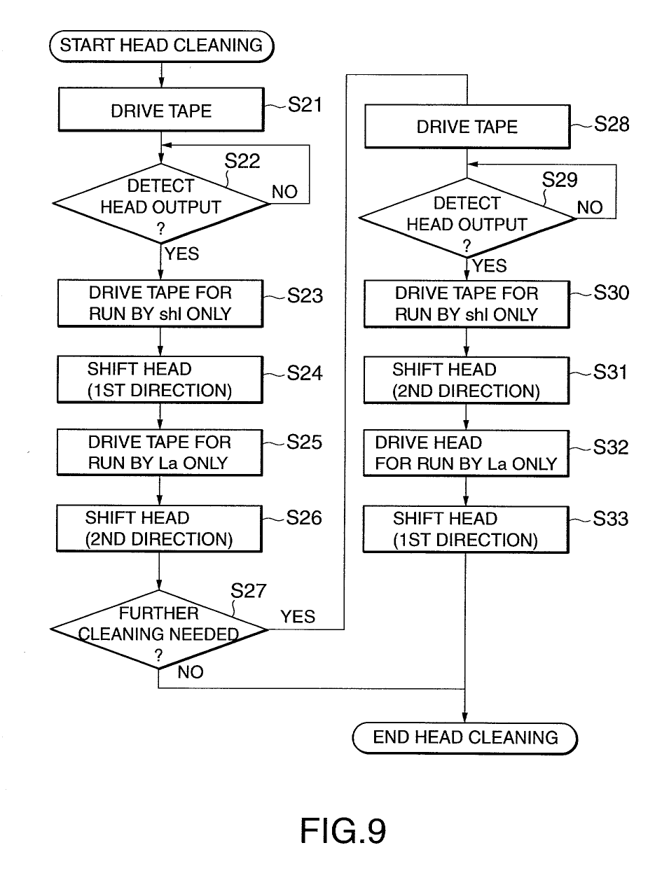

The operation of third embodiment of the invention will now be described with reference to FIG. 8A, FIG. 8B and FIG. 9. FIG. 8B shows an enlarged view of part C in FIG. 8A, seen in the direction of the tape surface (indicated by arrow D) The procedure of this operation applies to a case in which the running direction of the cleaning tape, as indicated by arrow 6a in FIG. 8B, matches the relative shifting direction of the magnetic head 1 from the magnetic pattern 71 toward the raised fiber section 61, which is the first direction 6a. First, the magnetic head cleaning tape 64 is run, kept in contact with the magnetic head 1 (S21).

At this step, the output of the magnetic head is monitored and, after a magnetic head output matching the magnetic pattern 71 is detected (YES at S22), the tape is further run by sh1 (to be exact, slightly more than sh1) and then stopped (S23). This stop position is exactly where the groove 30 between the magnetic head bumps is present over the flexible raised fiber section 61.

Next, the magnetic head 1 is shifted in the first direction (toward one end the cleaning tape 6 in its widthwise direction) normal to the running direction of the tape to a position where one end of the tape 64 and one end of the magnetic head 1 meet each other (S24). The tape 64 need not be shifted until that one end of the tape and that one end of the magnetic head 1 meet, and this is true of their respective other ends. This shift causes the dust matter 5 stuck to the bottom face of the groove 30 between the bumps to be scraped off with the tips of the raised fibers, and the dust matter 5 is thereby removed. Then, after running the tape 64 as far as La (S25), the head 1 is shifted in the second direction (toward the other end of the tape in its widthwise direction) reverse to the first direction to a position where the other end of the tape 64 and the other end of the magnetic head 1 meet each other to return the head 1 to its original position (S26). Since this shift of the head for its return is accomplished away from the raised fiber section 61, the dust matter 5 will never stick to the magnetic head 1 again.

Hereupon addition, as required, of a sequence (S28 through S33) which is the same as S21 through S26 except that the shifting direction of the head is reverse further enhances the dust matter removing effect. Thus, the head shifting direction at S31 shall be the second direction reverse to that at S24, and the head shifting direction at S33 shall be the first direction reverse to that at S26. In all other respects, the sequence of S28 through S33 is the same as that of S21 through S26. The direction of driving the tape is supposed to be the same. As the operation described above does not use the magnetic pattern 72, the magnetic pattern 72 shown in FIG. 8A need not be present.

As a variation of the third embodiment, the following operation is also possible. As shown in FIG. 8B, the magnetic head cleaning tape 64 in which the second magnetic pattern 72 is arranged in addition to the first magnetic pattern 71 in the vicinity of the raised fiber section in the other direction and sh2 away from the same, even if the running direction of the cleaning tape is reversed, dust matter can be removed in the same manner as described above by shifting the magnetic head 1 by a distance of sh2 after it has detected the second magnetic pattern 72, then stopping the tape, and shifting the magnetic head 1 in a direction normal to the running direction of the tape. Thus, the magnetic head cleaning tape 64 can be used for cleaning in both directions of its running, resulting in an enhanced efficiency of the use of the cleaning tape.

The third preferred embodiment of the present invention provides, in addition to the advantage of the second embodiment, the benefits of more reliable and accurate control of the distance of tape running required for one round of dust removal from between bumps because the position of raised fibers is confirmed by reading the data of the magnetic patterns 71 and 72 and of prevention of unnecessary tape running, resulting in an increased frequency of cleaning per given tape length. Furthermore, as the magnetic head cleaning tape can be used on both ways of its running, there is the additional benefit of an enhanced efficiency of the use of the cleaning tape.

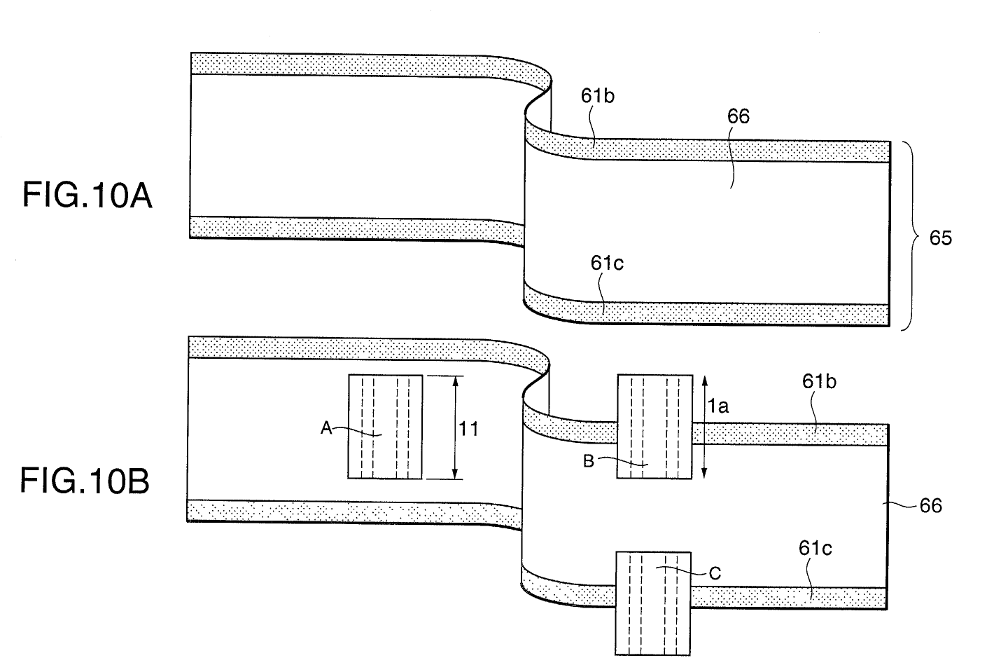

Next, the fourth preferred embodiment of the present invention will be described with reference to FIGS. 10. As shown in FIG. 10A, the magnetic head cleaning tape 65, which embodies the invention in this mode, has flexible raised fibers on its surface, and its flexible raised fiber sections 61b and 61c are at two ends of the tape in its widthwise direction and formed continuously in the direction of the tape length. The central section 62 of the tape either has a woven base or is 5 an abrasively coated medium.

Removal of dust matter 5 from the groove 30 between the head bumps by the magnetic head cleaning tape 65, embodying the invention as described above, is accomplished in the following manner. Usually, the magnetic head 1 is facing the S10 central section 66 of the cleaning tape 65 as indicated by position A in FIG. 10B. As the cleaning tape 6 is run in this state, the bump surface of the magnetic head can be cleared of foreign matter stuck to it. After running the tape to some extent in a state in which the magnetic head faces the middle of the tape, the magnetic head is shifted to the raised fiber section 61b at one end of the tape. At this step, the magnetic head is shifted so that it be scraped and wiped by the raised fiber section to position B slightly beyond half of its width 11.

Next, after running the tape 65 as far as or farther than the head length and stopping it, the magnetic head is shifted to the other end of the tape, and similarly scraped and wiped by the raised fiber section 61c to position C slightly beyond the width 11 of the magnetic head. Then, after running the cleaning tape 65 as far as or farther than the head length, the magnetic head is returned to the central section 66 of the tape to end this cleaning cycle.

The fourth preferred embodiment of the present invention provides, in addition to the advantage of the first embodiment, the benefit of cleaning the head bump surface usually by using the central section of the tape and, as required, removing dust matter accumulated in the groove between the magnetic head bumps by using the raised fiber sections at both ends of the tape.

To add, although the foregoing description of the first through fourth embodiments suppose that the magnetic head has two bumps, obviously the invention can be similarly applied if the number of magnetic head bumps is three or more.

A first advantage of the present invention is enhanced writing/reading reliability of the magnetic tape apparatus.

The reason is that dust matter in the groove between the head bumps can be efficiently removed, which was impossible by any conventional magnetic head cleaning tape, so that dust matter in the groove between the bumps can be prevented from floating on the head surface and obstructing the write/read operations while the tape is running.

A second benefit of the invention is improved maintenance ease of the magnetic tape apparatus.

The reason is that, while dust matter in the groove between the magnetic head bumps deep in the magnetic tape apparatus can be wiped off with a swab or the like, this method would require exposure of the magnetic head by disassembling the magnetic tape apparatus or otherwise, and its execution would require specialized skills. The use of the magnetic head cleaning tape according to the invention would enable even an unskilled person to easily remove dust matter dust matter in the groove between head bumps, and this contributes to the maintenance ease of the magnetic tape apparatus,

While this invention has been described with reference to illustrative embodiments, this description is not intended to be construed in a limiting sense. Various modifications of the illustrative embodiments, as well as other embodiments of the invention, will be apparent to persons skilled in the art upon reading this description. It is therefore contemplated that the appended claims will cover any such modifications or embodiments as fall within the true scope of the invention.

What is claimed is:

1. A magnetic head cleaning tape for cleaning a magnetic head having a groove in the vicinity of the face of each magnetic head coming into contact with a magnetic tape, the cleaning tape comprising:
flexible raised fibers longer than the depth of said groove and a tape base, wherein the flexible raised fibers are provided on the surface of said tape base.

2. The magnetic head cleaning tape, as claimed in claim 1, wherein:
the flexible raised fiber section, which is an area of said tape base on which said flexible raised fibers are provided, is formed all over in the widthwise direction of the tape and continuously in the direction of the tape length.

3. The magnetic head cleaning tape, as claimed in claim 1, wherein:
the flexible raised fiber section, which is an area of the tape base on which said flexible raised fibers are provided, is periodically provided in the direction of the tape length and all over in the widthwise direction of the tape in the area where said flexible raised fiber section is formed.

4. The magnetic head cleaning tape, as claimed in claim 3, wherein:
La>Lh and Lb>>Lh, m·L=2·n·Lh, where La is the length of the flexible raised fiber section in the running direction of the tape; Lb, the distance to the adjoining flexible raised fiber section; L=La+Lb, the period of the flexible raised fiber section; Lh, the length of each magnetic head in the direction of the tape length; and m and n, mutually prime integers.

5. The magnetic head cleaning tape, as claimed in claim 3, wherein:
La>Lh and Lb>Lh, where La is the length of said flexible raised fiber section in the running direction of the tape; Lb, the distance from an end of said flexible raised fiber section to the adjoining flexible raised fiber section; L (=La+Lb), the period of the flexible raised fiber section; and Lh, the length of the magnetic head in the direction of the tape length; and
in the vicinity of one end of each flexible raised fiber section is provided at a first distance a magnetic pattern all over the section in the widthwise direction of the tape.

6. The magnetic head cleaning tape, as claimed in claim 5, wherein:
arrays of two different magnetic patterns are on two sides of the flexible raised fiber section, a first magnetic pattern is provided away from said flexible raised fiber section by said first distance, and the array of a second magnetic pattern differing in pattern information is provided on the reverse side to said first pattern array away from said flexible raised fiber section by a second distance.

7. The magnetic head cleaning tape, as claimed in claim 1, wherein:
the flexible raised fiber sections, which are areas having said flexible raised fibers on said tape base, are provided at both ends in the widthwise direction of the tape, and continuously formed in the direction of the tape length.

8. The magnetic head cleaning tape, as claimed in claim 1, wherein:
the material of said tape base is polyester fibers, and that of said flexible raised fibers is also polyester fibers.

9. The magnetic head cleaning tape, as claimed in claim 5, wherein:
the magnetic pattern arrays are formed of a magnetic material stuck onto said tape base.

10. The magnetic head cleaning tape, as claimed in claim 5, wherein:
the magnetic pattern arrays are formed by weaving fibers containing a magnetic material into the material itself of the magnetic tape.

11. A method for a magnetic tape apparatus to clean its magnetic head, said magnetic tape apparatus having a means for running a cleaning tape and a means for shifting the position of the magnetic head in the widthwise direction of the tape, the cleaning tape having over its tape base a flexible raised fiber section in which flexible raised fibers are formed to be oriented in the depthwise direction of a groove in the magnetic head having that groove in the widthwise direction of the tape, and further formed all over in the widthwise direction of the tape and continuously in the direction of the tape length, said method comprising:
running said cleaning tape over a predetermined distance;
shifting said magnetic head toward one end of said cleaning tape in its widthwise direction;
running the cleaning tape in that state over a prescribed distance and stopped;
shifting said magnetic head toward the other end of said cleaning tape;
running said cleaning tape and stopping it again; and
shifting said magnetic head to its original position, i.e. the central section of the cleaning tape in its widthwise direction.

12. A method for a magnetic tape apparatus to clean its magnetic head, said magnetic tape apparatus having a means for running a cleaning tape and a means for shifting the position of the magnetic head in the widthwise direction of the tape, the cleaning tape having over its tape base a flexible raised fiber section, which is an area on said tape base and in which flexible raised fibers are formed to be oriented in the depthwise direction of a groove in the magnetic head having that groove in the widthwise direction of the tape, the flexible raised fiber section being provided periodically in the lengthwise direction of the tape and over the full width of the tape in the area where said flexible raised fiber section is formed, and relationships of La>Lh and Lb>>Lh, m·L=2·n·L hold for the cleaning tape, where La is the length of the flexible raised fiber section in the running direction of the tape; Lb, the distance to the adjoining flexible raised fiber section; L=La+Lb, the period of the flexible raised fiber section; Lh, the length of each magnetic head in the direction of the tape length; and m and n, mutually prime integers; said method comprising:
running said cleaning tape over a predetermined distance;
shifting said magnetic head toward one end of said cleaning tape in its widthwise direction;
running said cleaning tape in that state as far as Lh and stopping it;
shifting said magnetic head toward the other end of said cleaning tape and returned to its original position;
running said cleaning tape as far as Lh and stopping it again;
shifting said magnetic head shifted farther toward the other end of the cleaning tape;
running said cleaning tape as far as Lh and stopping it again;
shifting said magnetic head to its original position, i.e. the central section of the cleaning tape in its widthwise direction, and the foregoing steps are repeated n times.

13. A method for a magnetic tape apparatus to clean its magnetic head, said magnetic tape apparatus having a means for running a magnetic head cleaning tape and a means for shifting the position of the magnetic head in the widthwise direction of the tape, wherein relationships of La>Lh and Lb>Lh hold, where La is the length of a flexible raised fiber section in the running direction of the tape; Lb, the distance from an end of said flexible raised fiber section to the adjoining flexible raised fiber section; L (=La+Lb), the period of the flexible raised fiber section; and Lh, the length of the magnetic head in the direction of the tape length; and in the vicinity of at least one end of each flexible raised fiber section is provided at a first distance a magnetic pattern all over the section in the widthwise direction of the tape; said method comprising:
monitoring the magnetic head output while running said cleaning tape;
further running the tape by sh1 and stopping it after detecting the magnetic head output;
shifting said magnetic head toward one end of the tape in its widthwise direction;
running said cleaning tape in that state as far as La; and
shifting said magnetic head toward the other end of the tape in its widthwise direction and returning it to its original position.

14. The magnetic head cleaning method, as claimed in claim 13, further comprising:
monitoring the magnetic head output while running said cleaning tape;
after detecting the magnetic head output, further running the tape by sh1 and stopping it;
shifting said magnetic head toward the other end of the tape in its widthwise direction;
running said cleaning tape in that state as far as La; and
shifting said magnetic head toward said one end of the tape in its widthwise direction and returning the head to its original position.

15. A method for a magnetic tape apparatus to clean its magnetic head, said magnetic tape apparatus having a means for running a cleaning tape and a means for shifting the position of the magnetic head in the widthwise direction of the tape, wherein relationships of La>Lh and Lb>Lh hold, where La is the length of a flexible raised fiber section in the running direction of the tape; Lb, the distance from an end of said flexible raised fiber section to the adjoining flexible raised fiber section; L (=La+Lb), the period of the flexible raised fiber section; and Lh, the length of the magnetic head in the direction of the tape length; and in the vicinity of one end of each flexible raised fiber section is provided at a first distance a first magnetic pattern all over the section in the widthwise direction of the tape, and a second magnetic pattern differing in pattern information is provided on the reverse side to said first pattern array away from said flexible raised fiber section by a second distance; said method comprising:
in a first running direction from the first magnetic pattern to said flexible raised fiber section in the vicinity:
monitoring the magnetic head output while running said cleaning tape;
further running the tape by sh1 and stopping it after detecting the first magnetic pattern;
shifting said magnetic head in a first direction in the widthwise direction of the tape;
said running cleaning tape in that state as far as La; and
shifting said magnetic head in a second direction reverse to the first direction in the widthwise direction of the tape; and
in a second running direction from the second magnetic pattern to said flexible raised fiber section in the vicinity:
monitoring the magnetic head output while running said cleaning tape;
further running the tape by sh2 and stopping it after detecting the second magnetic pattern;
shifting said magnetic head in the first direction in the widthwise direction of the tape;
running said cleaning tape in that state as far as La; and
shifting said magnetic head in the first direction reverse to the second direction in the widthwise direction of the tape.
